(19) United States
(12) Patent Application Publication
(10) Pub. No.: US 2011/0246535 A1
(43) Pub. Date: Oct. 6, 2011

(54) Apparatus and Method for Constructing Data Applications in an Unstructured Data Environment

(75) Inventors: Nathan T. Freeman, Canton, GA (US); Colin Macdonald, Canton, GA (US); Tim Tripcony, Canton, GA (US); Luz Londono, Acworth, GA (US); Jennifer Meade, Canton, GA (US)

(73) Assignee: GROUP BUSINESS SOFTWARE AG, New York, NY (US)

(21) Appl. No.: 13/007,374

(22) Filed: Jan. 14, 2011

Related U.S. Application Data
(60) Provisional application No. 61/295,468, filed on Jan. 15, 2010.

(51) Int. Cl. G06F 7/00

(52) U.S. Cl. 707/803; 707/E17.044

(57) ABSTRACT

A database abstraction layer provides structured access to an unstructured database. The database abstraction layer imposes a relational structure on the otherwise unstructured data, so the data may be accessed as though it were stored in a relational database.

### CROSS REFERENCE TO RELATED APPLICATIONS

This application claims the benefit of U.S. Provisional Patent Application No. 61/295,468, filed Jan. 15, 2010, titled “Apparatus and Method for Constructing Data Applications in an Unstructured Data Environment,” the entire contents of which are hereby incorporated by reference herein, for all purposes.

### TECHNICAL FIELD

The present invention relates to computer-implemented construction of data applications, and more particularly to construction of such applications in an unstructured data environment, and for operation thereof in an unstructured environment.

### BACKGROUND ART

Unstructured data environments are widely known in the prior art, and have been implemented, for example, in the Domino server providing Lotus Notes functionality to computers accessing the Domino server. Domino and Lotus Notes are software products and trademarks of International Business Machines Corp. of Armonk, New York. As used herein, unstructured data means computer-stored data that does not include a pre-defined schema and may not be normalized. Unstructured data environments are typically contrasted with relational database environments, in which data is stored in highly structured fashion. In a normalized structured data environment, data may be stored in a manner that avoids redundant storage of data.

Many organizations have large investments in their unstructured data, which in many cases represents years of development. For example, many organizations have developed or maintain Lotus Notes databases and application programs. However, developing new application programs that access existing unstructured databases requires detailed knowledge of the contents of the databases, as well as time-consuming programming to implement relationships among the data. In contrast, developing application programs that access relational databases is relatively straight forward, because the relational databases already have predefined schemas that define relationships among data elements.

Furthermore, unstructured databases likely contain data that is redundant, i.e., the data is not normalized. For example, a non-normalized database that stores information, such as skills, about employees may include a separate record for each skill that an employee possesses. However, each such record may also store the employee's address.

In a particularly problematic example, a given employee possess two or more skills, and each skill record for the employee contains a different employee address. For example, the employee may have moved between acquiring the first and the second skill, and the first skill record may not have been updated after the move. In this case, the database contains conflicting information about the employee's address.

Application programs that access unstructured data typically include complex algorithms to deal with data redundancy and the possibility of inconsistent data, whereas application programs that access normalized relational databases avoid this complexity, because well-defined relational databases prevent storing redundant data.

Thus, many organizations prefer to develop application programs that access only relational databases. However, such a constraint on the development of new application programs precludes their accessing the many existing Lotus Notes or other unstructured databases that the organizations have spent considerable resources building and populating with data. Converting existing unstructured databases to relational counterparts would be time consuming and expensive. Furthermore, existing application programs would also have to be converted to access the newly-created relational databases, further adding to the cost of such a conversion. These organization are, therefore, faced with a Morton's Fork: retain unstructured databases and continue developing costly application programs for them or go through a costly and disruptive process of converting exiting unstructured databases to relational databases.

### SUMMARY OF EMBODIMENTS

In a first embodiment of the invention there is provided a non-volatile computer-readable storage medium encoded with instructions which, when loaded into a computer, establish a computer-implemented method for constructing a data application for operation in a computer system running an unstructured data environment, the construction of the application being accomplished in the environment. The computer implemented methods includes establishing processes running in the computer system that define properties of, and relative behavior of, data entities in an abstraction layer, such data entities including module, index, record, item, and wire. The data entities are configured to support reading and writing to storage in the data environment through a wire and through an item. The method also includes receiving and storing a user data model input defining a data model using the data entities. Upon receipt of a user signal, the method proceeds to process the data model input to develop a representation reflecting the data model, and generates signals defining a display of the representation and the application. The display permits user interaction as specified in the data model input so that the resulting data application implements normalized data in the unstructured data environment.

In a related embodiment the computer-implemented method includes establishing processes running in the computer system that define properties of, and relative behavior of, presentation entities in a presentation layer, the presentation entities including grouplet, field set, field, view, and column. In this embodiment, the method also includes receiving and storing a user presentation input defining a presentation for the data model, using the presentation entities. Moreover, the method includes, on receipt of the user signal, processing the data model input to develop a representation of the presentation and its linkage to the data model, and generating signals defining a display of the representation and the application, such display permitting user interaction as specified in the data model input and the presentation input.

In a further related embodiment, the presentation entities include group space.

Another embodiment of the present invention provides a non-volatile computer-readable storage medium encoded with instructions which, when loaded into a computer, establish a computer-implemented method for constructing a data application for operation in a computer system running an unstructured data environment, the construction of the application being accomplished in the environment. The method of this embodiment includes establishing processes running in the computer system that (i) define properties of, and relative behavior of, data entities in an abstraction layer, such data entities including module, index, record, item, and wire, and (ii) define properties of, and relative behavior of, presentation entities in a presentation layer, the

presentation entities including grouplet, field set, field, view, and column. The data entities are configured to support reading and writing to storage in the data environment through a wire. The method also includes receiving and storing a user data model input defining a data model using the data entities, receiving and storing a user presentation input defining a presentation for the data model, using the presentation entities. In this method, on receipt of a user signal, the data model input and the presentation input are processed to develop a representation of the presentation and its linkage to the data model, and signals defining a display of the representation and the application are generated. The display permits user interaction as specified in the data model input and the presentation input so that the resulting data application implements normalized data in the unstructured data environment.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of an unstructured database and a legacy application program that accesses data stored in the unstructured database, according to the prior art.

FIG. 2 is a schematic block diagram illustrating a database abstraction layer providing structured access to the unstructured database of FIG. 1, according to an embodiment of the present invention.

FIG. 3 is a schematic block diagram of a model-view-controller software architecture, according to the prior art.

FIG. 4 is a schematic block diagram of an exemplary wire relating two records, according to an embodiment of the present invention.

FIG. 5 is a flow-chart illustrating a computer-implemented method in accordance with an embodiment of the present invention for constructing a data application for operation in a computer system running an unstructured data environment, such as the unstructured database of FIG. 1 by using the database abstraction layer and relationship information of FIG. 2.

FIG. 6 is a flow-chart illustrating a further embodiment of the invention depicted in FIG. 1, in which a presentation layer is also employed.

FIG. 7 is a representation of a computer display of a launch page in accordance with the embodiment of FIG. 6.

FIG. 8. is a representation of a computer display of the launch page of FIG. 7 with a slide bar expanded to show grouplets and selection of a grouplet to be displayed.

FIG. 9 is a representation of a computer display of a grouplet selected in FIG. 4.

FIG. 10 is a representation of a computer display of data in a grouplet from FIG. 9.

FIG. 11 is a representation of a computer display of a data entry page in accordance with the embodiment of FIG. 2.

FIG. 12 is a representation of a computer display illustrating layout of a product list view in accordance with the embodiment of FIG. 6.

FIG. 13 is a representation of a computer display of a module selection page in accordance with the embodiment of FIG. 6.

FIG. 14 is a representation of a computer display of a page for defining a module in accordance with the embodiment of FIG. 6.

FIG. 15 is a representation of a computer display of a page for defining a record in accordance with the embodiment of FIG. 6.

FIG. 16 is a representation of a computer display of a page for defining an item's name and type in accordance with the embodiment of FIG. 2.

FIG. 17 is a representation of a computer display of two pages having definition lists for a user interface displayed thereon in accordance with the embodiment of FIG. 6.

FIG. 18 is a representation of a computer display of two pages displaying a specification of keywords for a field definition in accordance with the embodiment of FIG. 6.

FIG. 19 is a schematic block diagram illustrating copying data from an unstructured datastore to a relational database system, according to another embodiment of the present invention.

### DETAILED DESCRIPTION OF SPECIFIC EMBODIMENTS

### Definitions

As used in this description and the accompanying claims, the following terms shall have the meanings indicated, unless the context otherwise requires:

A “computer system” includes a network of computers that may be configured to include a server and one or more clients and, in an alternative embodiment, a single free-standing computer.

An “unstructured data environment” is a computer environment supporting reading and writing of data without a pre-existing schema in which each discrete data entity describes only itself and no other data. Unstructured means not structured in a relational fashion. Thus, unstructured data does not have keys and is not normalized, as it would be in a relational database.

A “module” is a database that includes one or more records.

An “index” is a data structure that facilitates the retrieval of data items and records from a module.

A “record” is a data entity contained in a module and having at least one item.

An “item” is a data entity contained in a record and is the lowest level of data entity.

A “wire” is a relation between two records wherever located, wherein the wire is stored as data and may be read by an application. A user interface may display a Link tab associated with a record (document) that allows a user to click to a related record responsive to the wire associated with the Link tab. A wire may be used to synchronize fields between two documents connected by the wire. Wires associated with the same field name in each of a number of records may be chained together, read recursively or read in reverse.

A “groupspace” is a user interface page on which grouplets or a list of grouplets may be displayed.

A “grouplet” is a data container of any form.

A “field” defines validation rules for an item in a record. The rules may determine if an error is produced by data in the item and a nature of the error.

A “field set” is a set of fields.

An embodiment of the present invention has been implemented in the Lotus Notes/Domino environment, and in various of the figures herein, this embodiment is called “Innova.”

In accordance with preferred embodiments of the present invention, methods and apparatus are disclosed for imposing a structure on otherwise unstructured data, so the data may be accessed as though it were stored in a relational database. In accordance with related embodiments, methods are disclosed for constructing a data application for operation in a computer system running an unstructured data environment. The construction of the application is accomplished in the unstructured data environment.

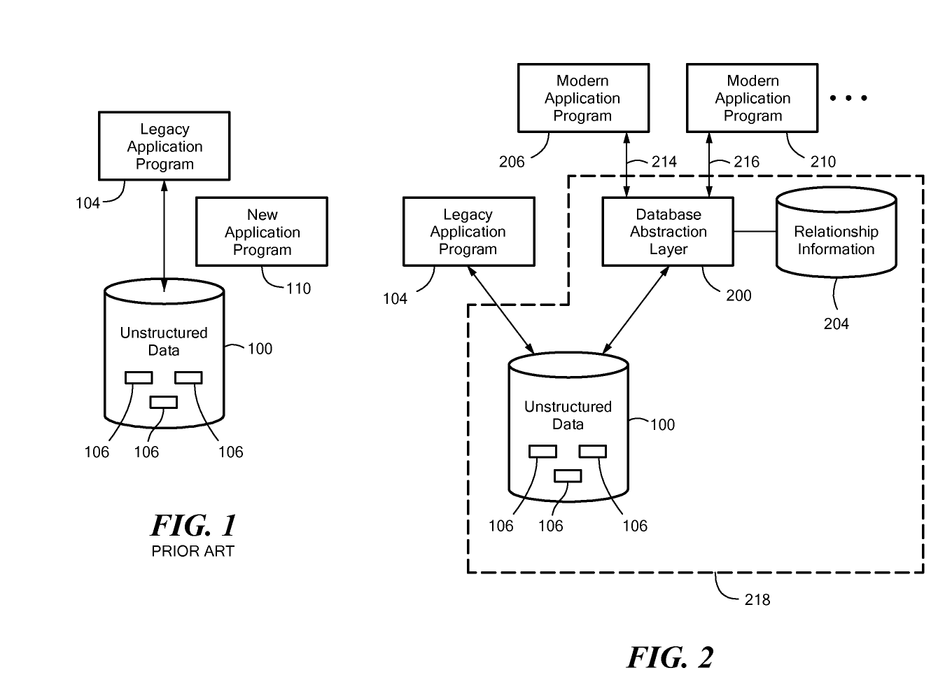

FIG. 1 is a schematic block diagram of an unstructured database 100, such as a Notes Storage Facility (NSF), and a legacy application program 104, such as Lotus Notes, that accesses data stored in the unstructured database 100, according to the prior art. The unstructured database 100 may store data, such as documents or records 106. For example, contact information, such as telephone numbers and postal and e-mail addresses of people may be stored in the records 106. Intermediate prior art software or hardware, such as a Domino server, that may be interposed between the legacy application program 104 and the unstructured database 100 to facilitate accessing the data 106 are omitted for clarity. The unstructured database 100, or the unstructured database 100 and the Domino server, provide examples of unstructured data environments.

The legacy application program 104 is written with intimate knowledge of the type of data stored in the unstructured database 100 and how (if at all) that data is organized However, no pre-defined schema exists for the unstructured database 100. The legacy application program 104 includes routines to search the data 104 stored in the unstructured database 100, retrieve necessary data, store addition data and, when necessary, delete selected data items. As noted, the database 100 is unstructured. Thus, any relationships among the records, documents, etc. 106 or elements of these records are necessarily implemented by the legacy application program 104, inasmuch as there are no predefined relationships among the data 106 that are imposed by the unstructured database 100. Furthermore, the unstructured database 100 may impose no constraints, such as field widths or field validation rules, on data stored in the unstructured database 100. The constraints on, or validations of, the data are imposed by the legacy application program 100.

If a new application program 110, such as an employee information system, is to be written to access the data 106 in the unstructured database 100, the new application program 110 can not take advantage of any predefined relationships, constrains, validations, etc., without including copies of routines from the legacy application program 104. However, obtaining copies of these routines may not be possible because, for example, the legacy application program 104 may be proprietary. Furthermore, even if such routines were available, integrating them into the new application program 110, which may be written under a different application development framework than the legacy application program 104, may be difficult. In other words, the new application program 110 must be written using the same (non-relational) data access paradigm used by the legacy application program 104.

FIG. 2 is a schematic block diagram illustrating an embodiment of the present invention providing structured access to the unstructured database 100 of FIG. 1. A database abstraction layer 200 maintains relationship information 204 about the data in the unstructured database 100. The relationship information 204 may also include field definitions, constraints, validations, etc. The relationship information 204 may be generated before or after (sometimes long after) the unstructured database 100 is created and populated with data 106. In some embodiments, graphical user interfaces (GUIs) to utility programs are used to facilitate generating the relationship information 204, examples of which are described below.

The relationship information 204 is somewhat similar to a schema. However, the relationship information 204 also includes information that enables the database abstraction layer 200 to access and manipulate the data 106 in the unstructured database 100, so as to emulate a relational database. That is, the relationship information 204 includes information about how data 106 is stored in the unstructured database 100, possible redundancies among the data 106 and relationships between pairs of elements of the data 106.

Using this relationship information 204, the database abstraction layer 200 imposes a structure on the data 106 stored in the unstructured database 100. For example, if the unstructured database 100 contains contact information records 106 that include name, company, street address, city, state, office and mobile telephone numbers, etc., relationship information 204 may be established, such as links between people who all work for a common employer. The relationship information 204 may be stored in any convenient location, including in the unstructured database 100, in another database (not shown) or in a separate file.

Modern application programs 206, 210, etc. make structured data access calls 214 and 216, such as data insert, query, update and delete, to the database abstraction layer 200. In some embodiments, the structured data calls may conform to the well-known Structured Query Language (SQL); however, in other embodiments, other syntax may be used and invocation mechanisms may be used. In response, the database abstraction layer 200 accesses and, where necessary, manipulates the data 106 in the unstructured database 100, so as to implement equivalent functionality.

For example, if a modern application program 206 issues a structured query, such as an select query, the database abstraction layer 200 uses the relationship information 204 to ascertain how to obtain the requested information from the data 106 stored in the unstructured database 100. Obtaining the requested information may involve several searches and/or record or document retrievals from the unstructured database 100. Furthermore, obtaining the requested information may involve parsing data retrieved from the unstructured database 100, such as if the retrieved data is not partitioned into fixed-length fields or if the contents of one retrieved data element 106 are used to identify another data element 106. Where necessary, the database abstraction layer 200 generates one or more synthetic table rows for delivery to the modern application program 206 in satisfaction of the structured query. The synthetic table row(s) may be made up of parts or all of one or more of the data elements 106.

If the modern application program 206 issues a structured insert or update request, the database abstraction layer 200 parses the table row, field, etc. provided by the modern application program 206, and the database abstraction layer 200 updates one or more existing data elements 106 in the unstructured database 100 and/or creates one or more new data elements 106 in the database 100 to effect the change requested by the modern application program 206. If the data in the unstructured database is not normalized, i.e., if information is stored redundantly, several data elements 106 may need to be written with similar or identical information. For example, if employee skill records contain addresses of the corresponding employees, and an employee's address is to be changed, but the employee possesses two or more skills, all the skill records for the employee should be updated to reflect the change in the employee's address.

The modern application programs 206, 210, etc. may request schema modifications, such as defining new relationships between data items. In response, the database abstraction layer 200 modifies or augments, as the case may be, the relationship information 204. Furthermore, additional modern application programs (not shown) may subsequently be developed and use the relationships defined in the relationship information 204, as though the unstructured database 100 were a relational database. These additional modern application programs may query the database abstraction layer 200, as though the abstraction layer were a schema, to ascertain information about the structure of the data, as though the unstructured database 100 were a relational database.

Thus, from the viewpoint of the modern application programs 206, 210, etc., the data 106 is stored in a virtual relational database system 218. Collectively, the database abstraction layer 200 and the relationship information 204 may be referred to as a relational database manager emulator, and collectively the unstructured database 100, the database abstraction layer and the relationship information 204 may be referred to as a relational database emulator. Nevertheless, legacy application programs, such as program 104, may continue to access the unstructured database 100, as before.

The relationship information 204 stores information about portions of the data elements 106 that may be treated as keys, so as to identify or select ones of the data elements 106 or portions thereof. In such a case, the relationship information 204 stores information, such as field name, field size, field position within the data element 106 or within records stored within the data element 106, so as to enable the database abstraction layer 200 to locate needed data elements 106. (Although the term “field” is used here to describe portions of the data elements 106, in this context field does not necessarily include validation rules. That is, the unstructured database 100 may not necessarily include its own field validation rules.) Optionally, the relationship information 204 also includes a sort order for the key, validation rules or constraints for key values and other portions of the data elements 106, etc. The relationship information 204 also stores information about relationships between or among two or more of the data elements 106 or portions thereof

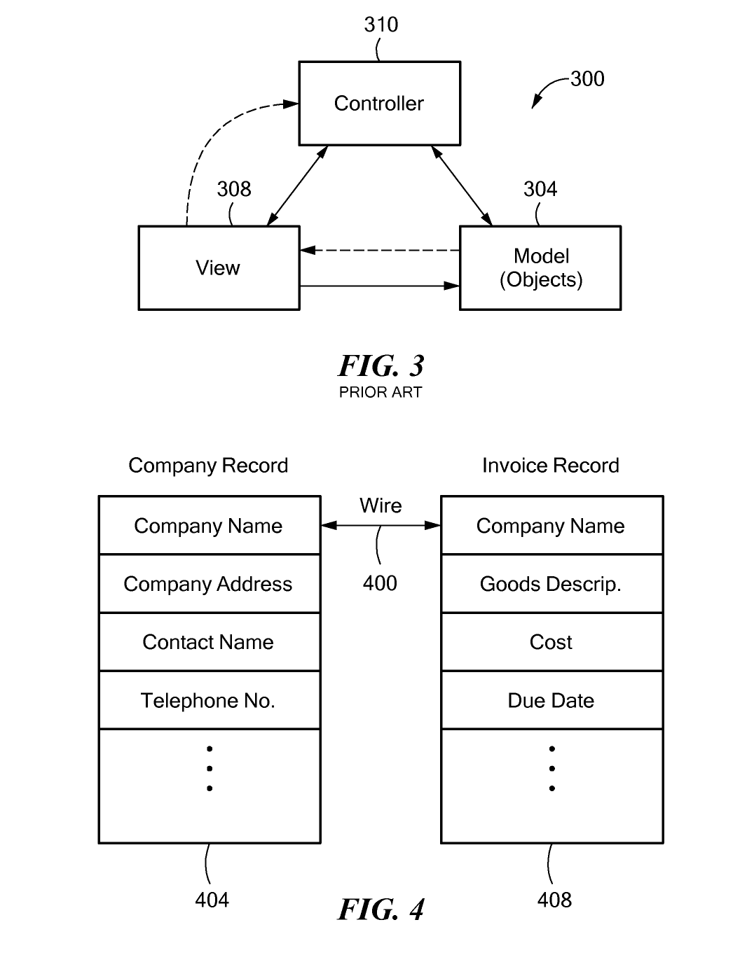

Model-View-Controller (MVC) is a well-known software architecture for software systems. FIG. 3 is a schematic block diagram of major components of a system 300 built according to the MVC architecture. An MVC system includes three major components: a model 304, a view 308 and a controller 310. Solid line arrows in FIG. 3 represent direct associations. Dashed line arrows represent indirect associations, such as via an observer.

The model 304 manages behavior and data of the application domain, responds to requests for information about its state and responds to instructions to change state. In event-driven systems, the model 304 notifies observers, through the view 308, when the information has changed, so the observers can react. The view 308 renders the model into a form suitable for interaction, typically as a user interface (UI) element. Multiple views 308 can exist for a single model 304 for different purposes. The controller 310 receives inputs and initiates responses by making calls on objects in the model 304. The controller 310 accepts input, via the view 308, from the user and instructs the model 304 and the view 308 to perform actions based on the input. An MVC application may be a collection of model-view-controller triads, each responsible for a different user interface element.

MVC architectures are often used in web-based applications, where the view 308 displays results using HTML-tagged data generated by the application. The controller 310 receives GET or POST input and decides what to do with it, while accessing domain objects in the model 304. For example, the controller 310 may invoke methods defined within objects in the model 304. These methods may implement business rules, such as validation rules, and carry out specific tasks, such as creating a new order in an order processing system.

In an MVC system, “domain logic,” i.e., application logic, is isolated from the user interface (UI), which is responsible for accepting input from a user and presenting output to the user. This isolation facilitates independent development, testing and maintenance of the domain logic and the user interface. The model 304 is not a database. Instead, the model 304 is both data and business/domain logic needed to manipulate the data in the application. Many applications use a persistent storage mechanism, such as a database, to store the model 304.

Returning to FIG. 2, the database abstraction layer 200 may be implemented in Java as part of a controller 310 in an MVC-architected application. As noted, the database abstraction layer 200 may be used to impose a relational structure on otherwise unstructured data 106. For example, if the unstructured data 106 represented contact information, the database abstraction layer 200 may be used to present that data to a modern application program 206 as though the data were stored in a relational database 218.

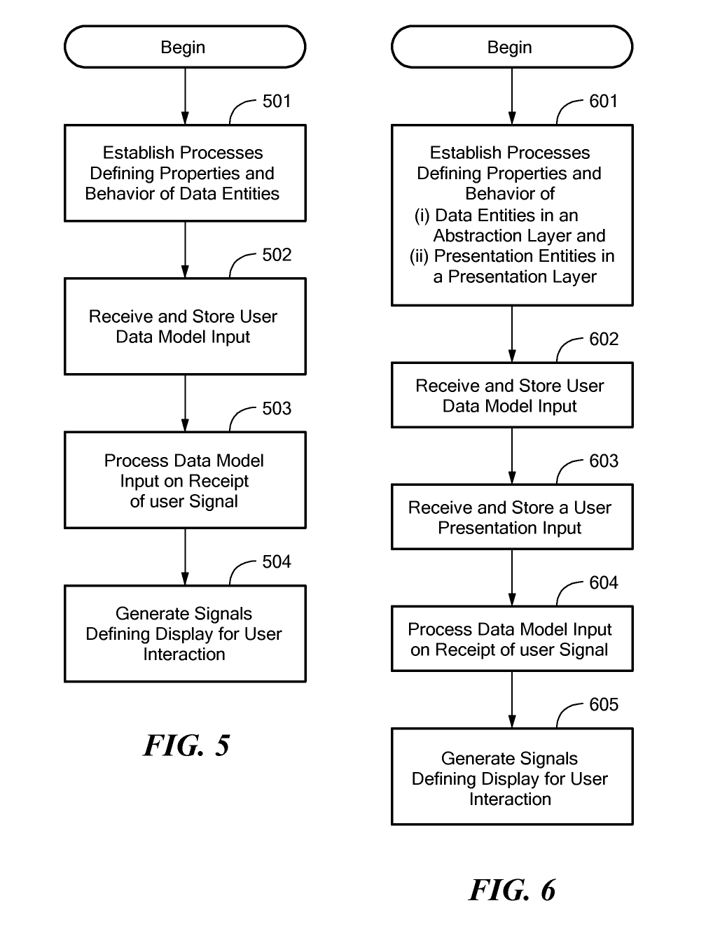

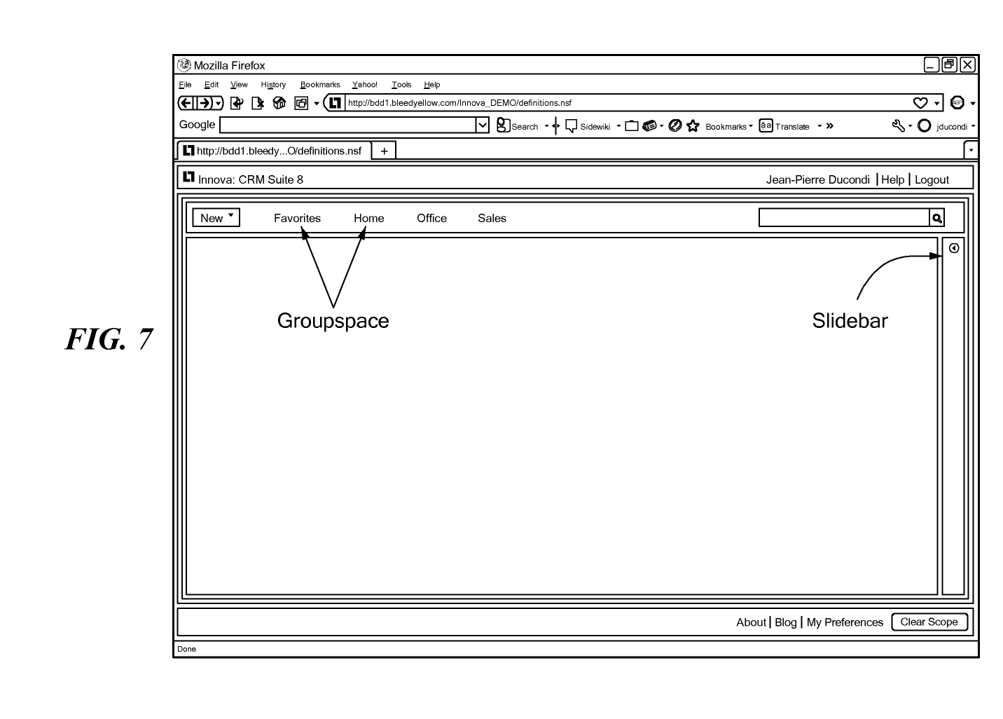

Computer-implemented methods of constructing a data application for operation in a computer system running an unstructured data environment, such as the unstructured database 100, are described below, with respect to FIGS. 5 and 6. Exemplary user interfaces are described, with reference to FIGS. 7-18, illustrating how the data may be used in a relational fashion, exploiting the relationships imposed by the database abstraction layer 200, despite the fact that the data is actually stored in an unstructured database. Other of FIGS. 7-18 are used to illustrate how relationships between elements of the data may be defined by a user.

Before delving into the user interface aspects, we here discuss the notion of a “wire.” As noted, a wire represents a relationship between two or more record types. For example, as schematically illustrated in FIG. 4, a wire 400 may represent a relationship between company records, such as company record 404, and invoice records, such as invoice record 408. The wire 400 includes information that enables the database abstraction layer 200 (FIG. 2) to locate one or more portions of the company record 404 that uniquely identify the company record 404, and to locate one or more portions of the invoice record 408 that uniquely identify the invoice record 408. Thus, if the database abstraction layer 200 receives a query requesting all invoices that are related to a particular company, the database abstraction layer 200 can retrieve the corresponding company record 404, read appropriate portions of the company record 404 (such as, for example, the “Company name” portion) and then search for invoice records that refer to that company name.

Wires, therefore, enable the database abstraction layer 200 to access data in an unstructured datastore, such as the unstructured database 100, to fulfill structured queries and other structured data access requests. However, wires can also be used to relate more than two types of data. For example, assume the datastore contains records describing projects, records describing people and records describing expenses. A wire (i.e., a relationship) may be used to relate expenses with the people who incurred the expenses and, perhaps, have requested reimbursement. A different wire may be used to relate people with the projects to which the people have been assigned. Wires may be chained together. For example, a wire may be defined to relate expenses to projects by relating expenses to people who incurred the expenses, and relating the people to their projects. In other words, wires may be defined that require traversing (as in traveling) along the wire, from record to record (such as from an expense record, through the related person record, to the related project record), from one end of the wire to the other or stopping along the way.

A wire may be implemented using a JavaBean. Prior to development of the database abstraction layer 200 (FIG. 2), establishing a relationship between data elements in an unstructured database 100, if that was even possible, would have required writing code. However, embodiments of the present invention enable users to establish such relationships via graphical user interfaces (GUIs), as discussed herein, without coding the relationships. Thus, these embodiments facilitate developing application programs that access structured data by reducing the amount of coding required.

FIG. 5 is a flow-chart illustrating a computer-implemented method in accordance with an embodiment of the present invention for constructing a data application for operation in a computer system running an unstructured data environment. In other words, the method for constructing the data application runs in an unstructured data environment, and the data application itself runs on a computer system in the unstructured data environment, such as the Lotus Notes/Domino environment. In process 501, there are established in the data environment processes running in the computer system that define properties of, and relative behavior of, data entities in an abstraction layer. These data entities include module, index, record, item, and wire. The data entities are configured to support reading and writing to storage in the data environment through a wire and through an item.

In process 502, the computer system receives and stores a user data model input defining a data model using the data entities. Such an input is provided by a user who defines the data model sought to be implemented in the application. Next, in process 503, after the system receives a user signal (such as for example, the invoking by the user of a web page understood by the processes established in process 501 to be such a signal), the computer system processes the data model input to develop a representation of the data model, and generates signals defining a display of the representation and the application, such display permitting user interaction as specified in the data model input. At this point the application, having been defined by the user, is complete and running in the environment, ready for the input of application data and the processing thereof. Remarkably, even though the overall environment is unstructured, the processes described herein cause the resulting data application to implement normalized data in the unstructured data environment.

FIG. 6 is a flow-chart illustrating a further embodiment of the invention depicted in FIG. 5, in which a presentation layer is also employed. More particularly, the process described as 501 in FIG. 5 is here expanded as process 601, so that there are established not only processes defining properties and behavior of data entities as in FIG. 5, but also processes defining properties of, and relative behavior of, presentation entities in a presentation layer. These presentation entities include groupspace, grouplet, field set, field, view, and column. In consequence, the processes of FIG. 6 include not only receiving and storing a user data model input, shown here as process 602 (which corresponds to process 502 in FIG. 5) but also, in process 603, receiving and storing a user presentation input. The user presentation input defines the user interface for the data application created by the processes herein. In consequence, the method further includes, in process 604, on the on receipt of the user signal, processing the data model input to develop a representation of the presentation and its linkage to the data model. Moreover, the method includes in process 605, generating signals defining a display of the representation and the application. Here, the display permits user interaction as specified in the data model input and the presentation input. The figures that follow show an implementation of the processes described in FIG. 6.

FIG. 7 is a representation of a computer display of a launch page, in accordance with the embodiment of FIG. 6. Computer displays of Innova are shown in the examples; however, other types of user interfaces may be used. Innova is a highly customizable product framework, with a standard user interface that, whilst being simple to use, provides a high degree of information access from a current context. The layout of the user interface is uniform for all modules of the application(s). The launch page is where the user begins works. It is similar to a portal where users may do their work. In some embodiments of the present invention, the different elements of the launch page include: groupspace, grouplets, a slide bar, and a “new” drop down menu. The slide bar contains available grouplets that can be dropped in a certain groupspace. The “new” action allows the creation of any new document type and is available all the time to the user.

A grouplet is a container for data of any kind. A grouplet can be used to display list type data, views or datagrids, record data, a graphic or chart, an embedded webpage or any combination thereof A groupspace is a background display area upon which a user can drag and drop grouplets, display forms and organize a working environment. Groupspaces are organized at the top of the screen. The active groupspace is highlighted. To activate a different groupspace, a user clicks on its name at the top of the screen.

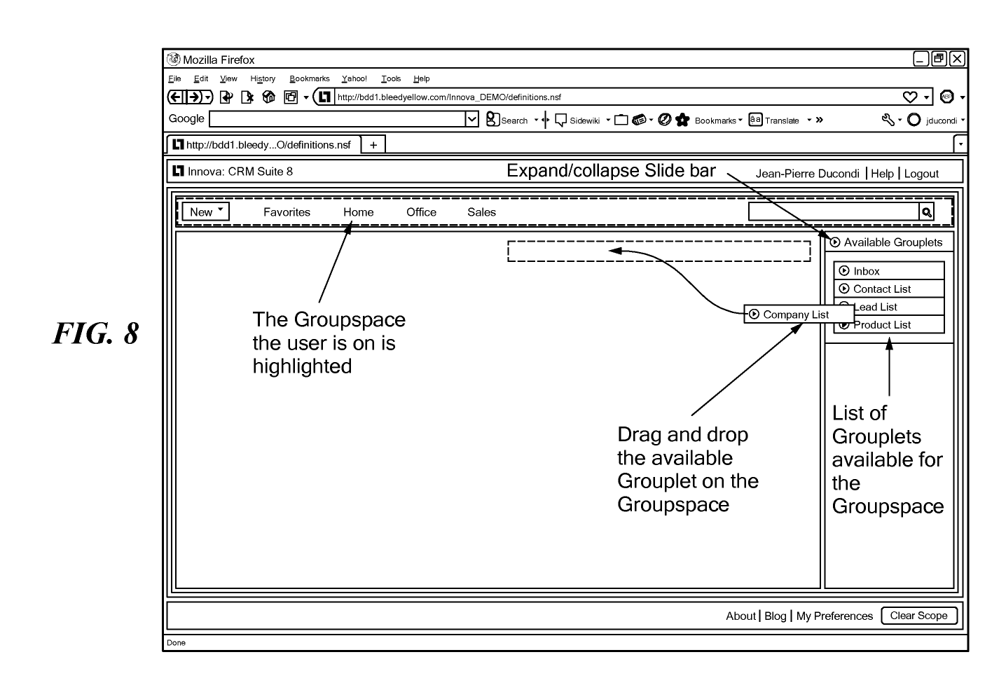

A sidebar slides in and out to provide access to grouplets that are available to be dragged on to the active groupspace. FIG. 8. is a representation of a computer display of the launch page of FIG. 7 with the slide bar expanded to show grouplets and the selection of a grouplet to be displayed. The slide bar can expand and, depending on the groupspace the user is in, allows the user to drag and drop the grouplets available for that groupspace.

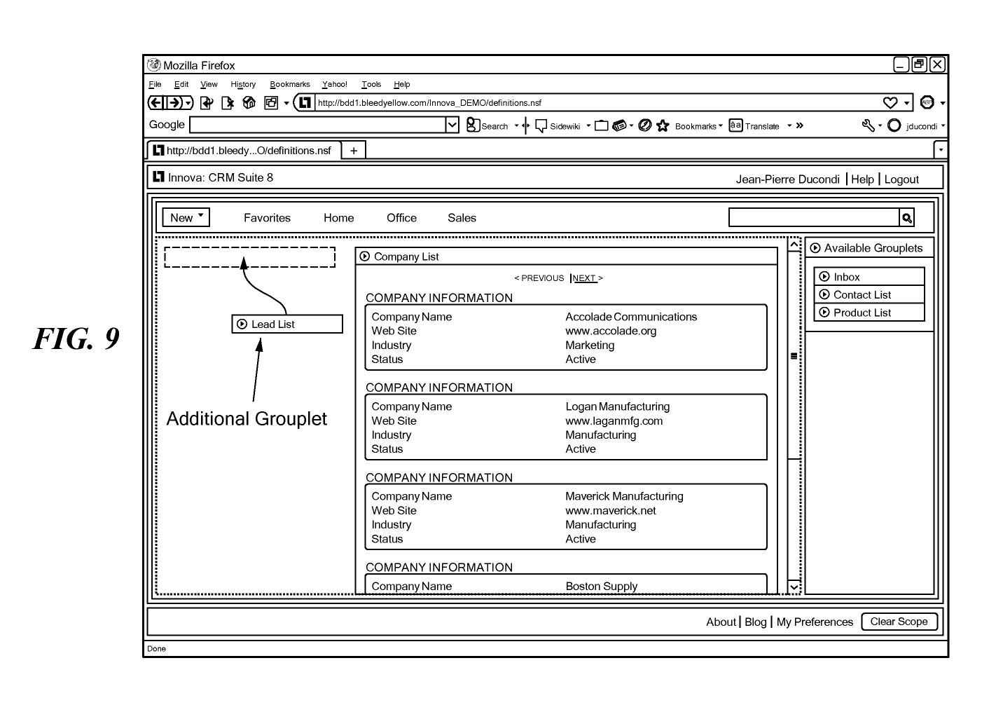

FIG. 9 is a representation of a computer display of a grouplet selected in FIG. 8.

The system allows a user to display and interact with record data through forms and views. Forms display fields that can be used to enter, modify or remove information from the system. Fields are organized on the form into a logical set of groupings called fieldsets. New records can be created by selecting the appropriate form-type from the NEW button. When selected, a new blank form is displayed within the active groupspace. A user can add information to the fields and then click the CREATE button at the bottom of the form to create a new record in the system.

Records may be edited in several ways. With inline editing, a user can change the value in an individual field by clicking on the pencil icon next to the field. Inline editing can be performed on data in forms and views. Alternatively, a user can open a form in edit mode to change the values of several fields at once. When done, the user clicks SAVE to update the backend data. A user can modify the value of one field across several records using the mass change feature by selecting all of the records that are to be updated, and then choosing MASS CHANGE. The user is presented with a list of fields that are editable. The user enters a value to replace the previous contents of a field on all of the selected records, and then selects SAVE.

Views are useful for displaying large amounts of data. There are three types of views: datagrid, tabular and list. Datagrid views allow a user to see data from one or more sources in a tabular format. Datagrids also allow the user to search for matching record types in one or more columns, as well as sort and re-sort the data based on a specific column. Searches can be performed using wildcards. For example, to find all names that begin with the letter “S” in a column that displays last names of people in the current dataset, a user would enter “s*.” Tabular views display a basic set of information in a tabular format. These views are not sortable or filterable. A list view is used to list information.

To make the application highly configurable, much application logic may be implemented other than as code. Three concepts are involved in reducing the amount of code required to implement an application: relationships between data elements, processes that are followed within an organization (i.e., workflows) and data validation. Each of these concepts is discussed below.

The first concept involves relationships between various elements, such as a relationship between an expense and a customer or a project. Whether the relationship is with the customer or the project may depend on the type of business being performed and can even vary between divisions within a company. According to embodiments of the present invention, relationships among natively-unstructured data are implemented with wires. Wires may be involved in two contexts: capturing relationships and extracting information from relationships.

The capture of relationships among previously unstructured data may be handled through a user interface. Users can relate records via type-ahead or by selecting a related record and choosing NEW and the related new record form type. For example, if a users wants to create a contact that is related to a company in the system, the user can select the related company document, and then choose NEW>Contact. A wire relates each field to the type of record (if any) that the field can point to or contain. Thus, when a user types-ahead some portion of a field's contents, the application can search for related records whose keys begin with the typed characters and offer the found records as choices. Similarly, if a field's content chooser is implemented as a pull-down list, the wire identifies the records that are related to the field and that can be chosen.

Information may be extracted from relationships when, for example, an application program queries a database abstraction layer 200 (FIG. 2), and the database abstraction layer uses the relationship information 204 to identify the appropriate data elements 106 necessary to satisfy the query.

The concept of workflow is well known. A workflow consists of a sequence of connected steps. It is a depiction of a sequence of operations, declared as work of a person, a group of persons, an organization of staff, or one or more simple or complex mechanisms. Workflow may be seen as any abstraction of real work, segregated in workshare, work split or other types of ordering. For control purposes, workflow may be a view on real work under a chosen aspect, thus serving as a virtual representation of actual work. The flow being described often refers to a document that is being transferred from one step to another.

A workflow is a model to represent real work for further assessment, e.g., for describing a reliably repeatable sequence of operations. More abstractly, a workflow is a pattern of activity enabled by a systematic organization of resources, defined roles and mass, energy and information flows, into a work process that can be documented and learned. Workflows are designed to achieve processing intents of some sort, such as physical transformation, service provision, or information processing. Many prior art software applications are available to manage workflows within organizations.

Field validation may involve checking whether a field is required and its range of valid values. This information, along with error message to be produced in case a user enters incorrect data, is stored in wires. The wires store definitions that define the behavior of the objects related by the wires.

The three concepts discussed above are translated into three primary abstractions: wire, workflow and field, as discussed below.

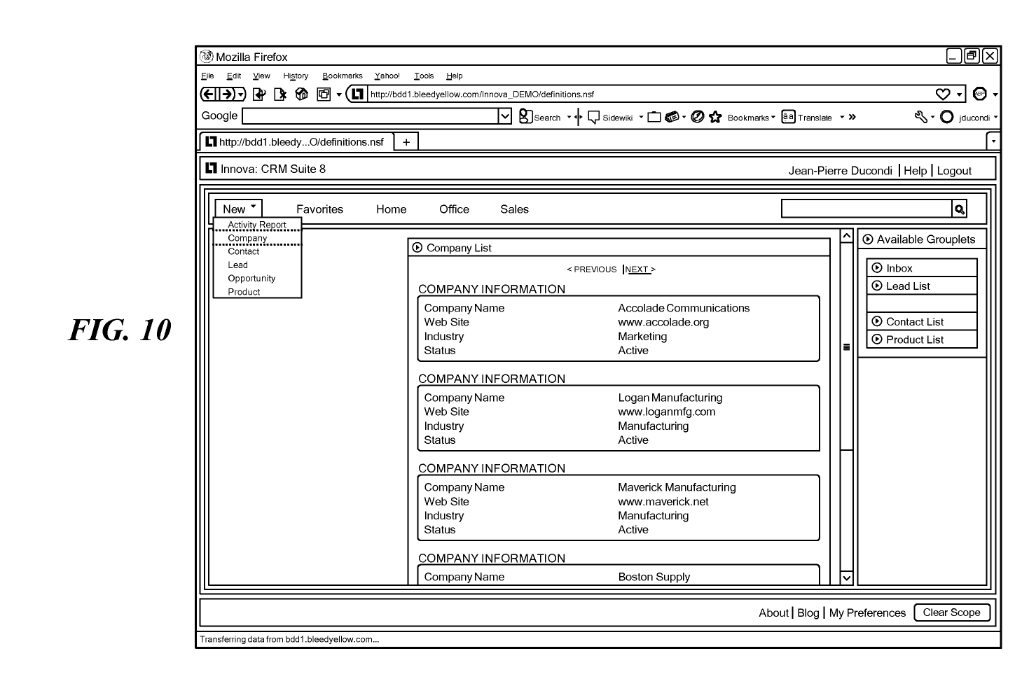

FIG. 10 is a representation of a computer display of data in a grouplet from FIG. 9. If a user wants to create a new document, the new toolbar allows a user to choose from one of various documents to create. Once the user selects the document he would like to make, a form is generated in its own groupspace wherein the user can create the new document. The relationship information 204 is used to define the fields of the form.

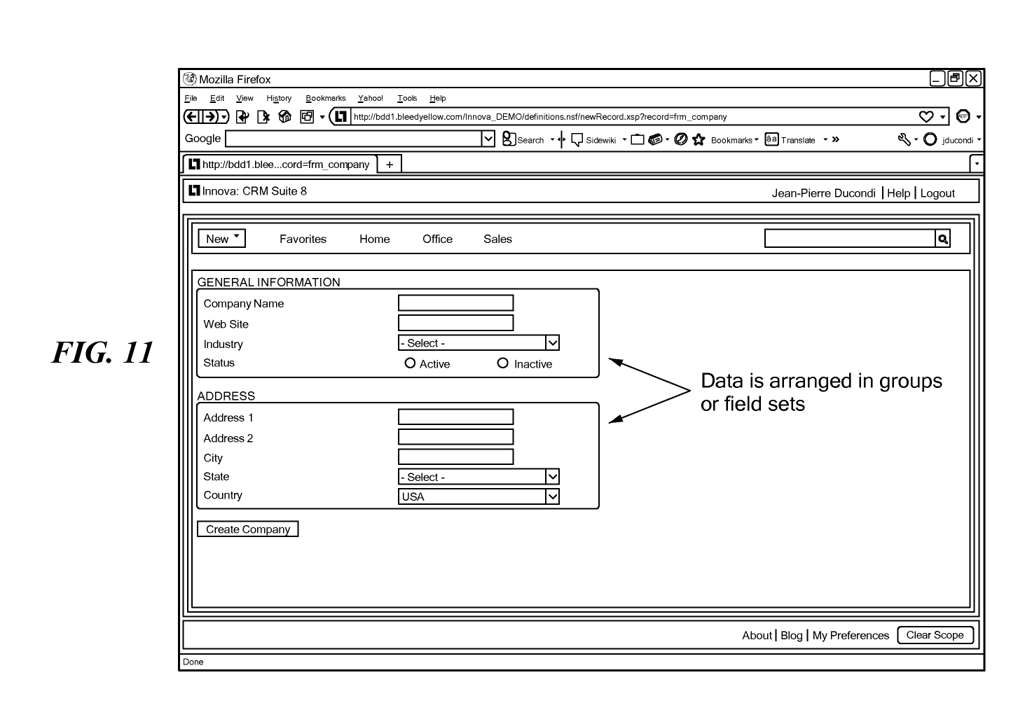

FIG. 11 is a representation of a computer display of a data entry page in accordance with the embodiment of FIG. 6.

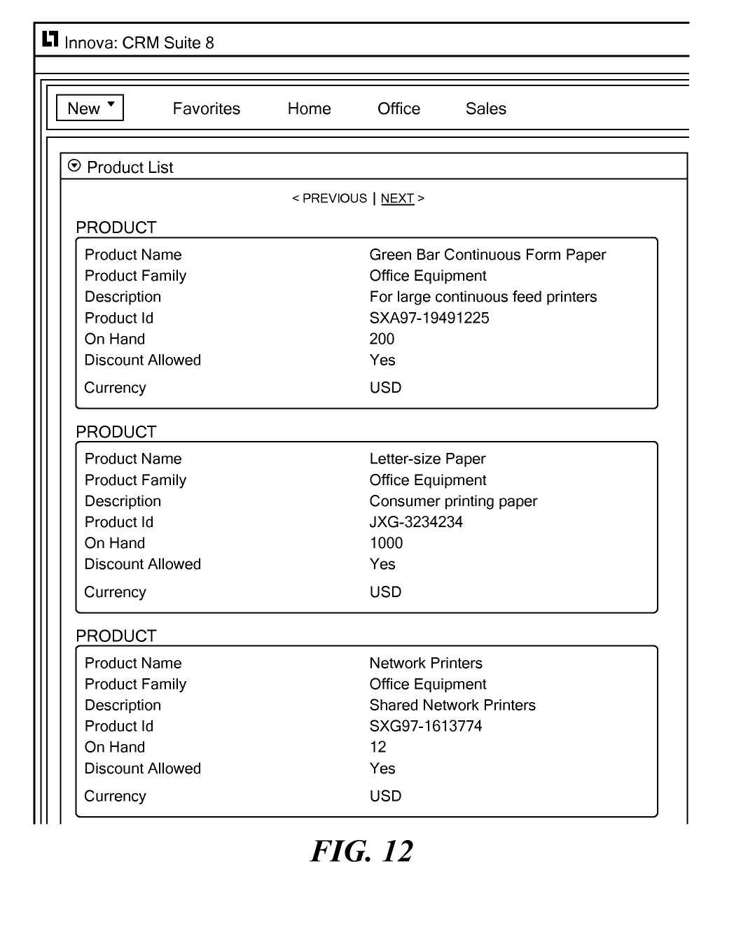

FIG. 12 is a representation of a computer display illustrating the layout of a product list view in accordance with the embodiment of FIG. 6.

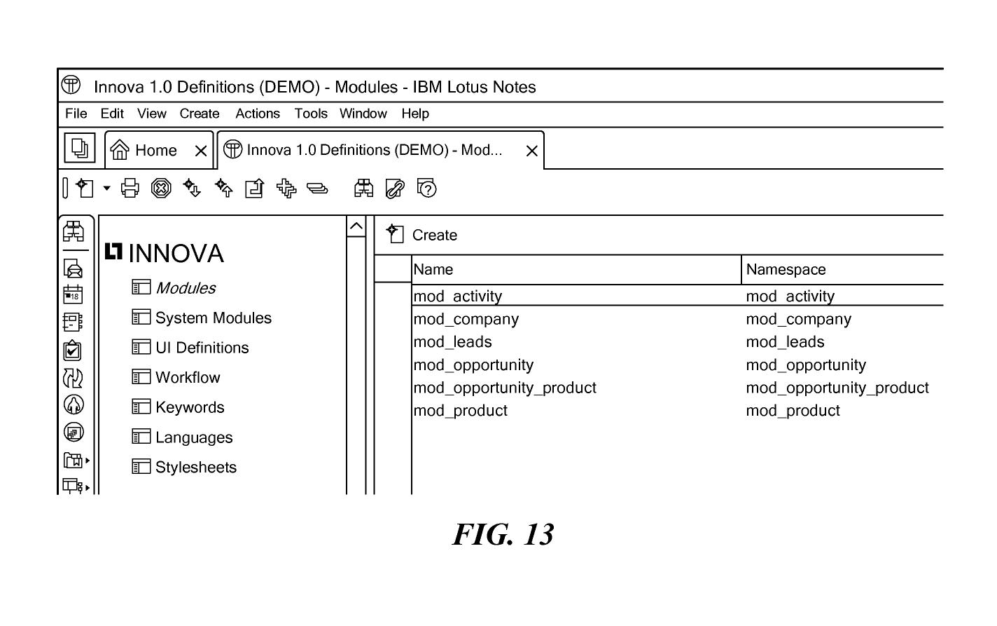

FIG. 13 is a representation of a computer display of a module selection page in accordance with the embodiment of FIG. 6. A module represents a database. Each module can have one or several records and index definitions.

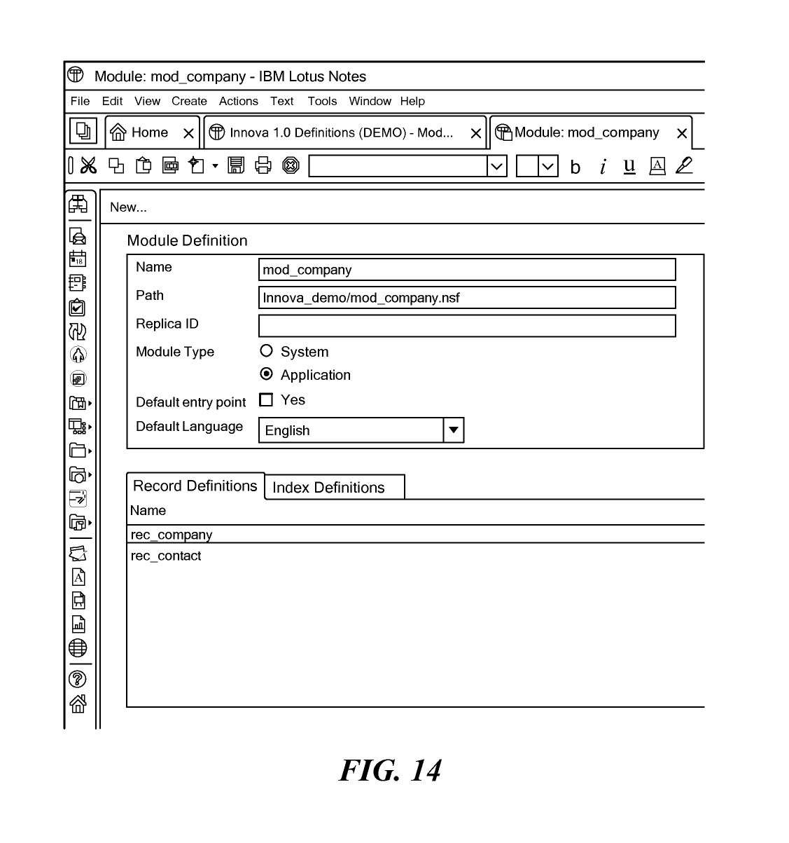

FIG. 14 is a representation of a computer display of a page for defining a module in accordance with the embodiment of FIG. 6.

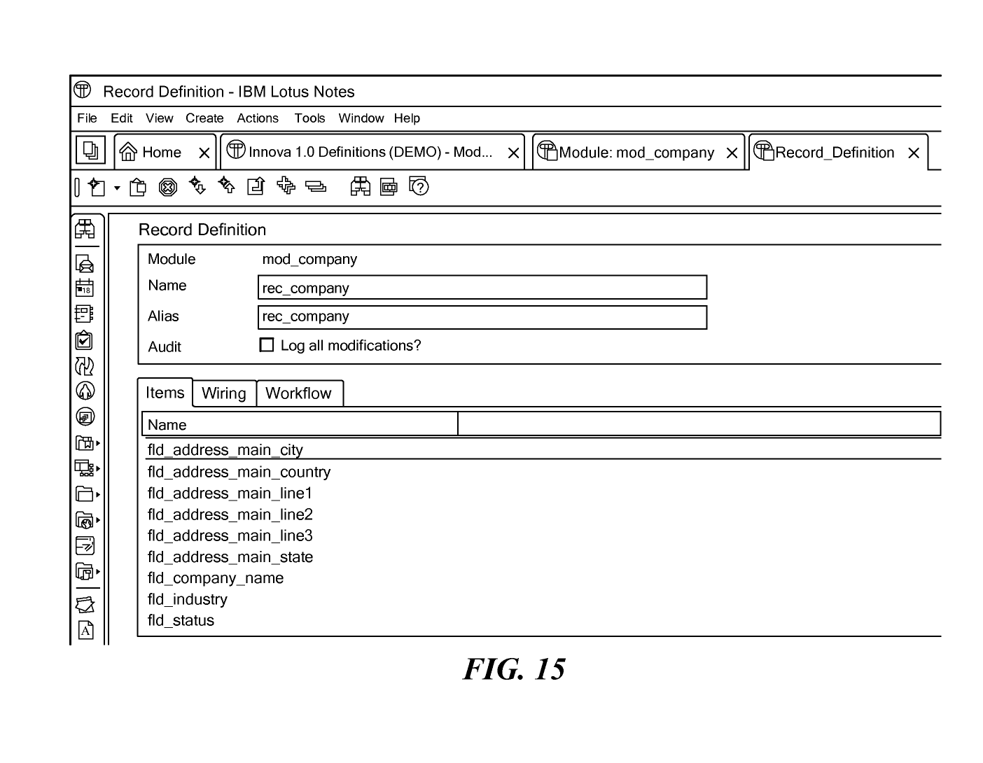

FIG. 15 is a representation of a computer display of a page for defining a record in accordance with the embodiment of FIG. 6. Records have items representing table fields.

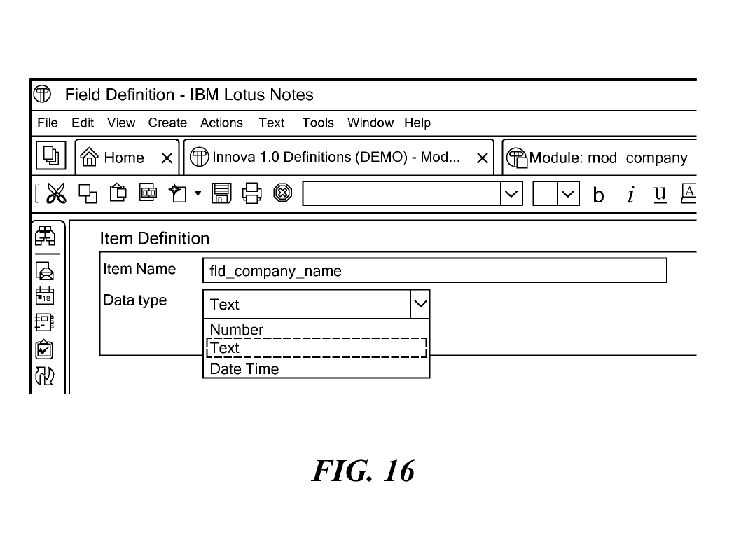

FIG. 16 is a representation of a computer display of a page for defining an item's name and type in accordance with the embodiment of FIG. 6. Each field item has a name and a data type.

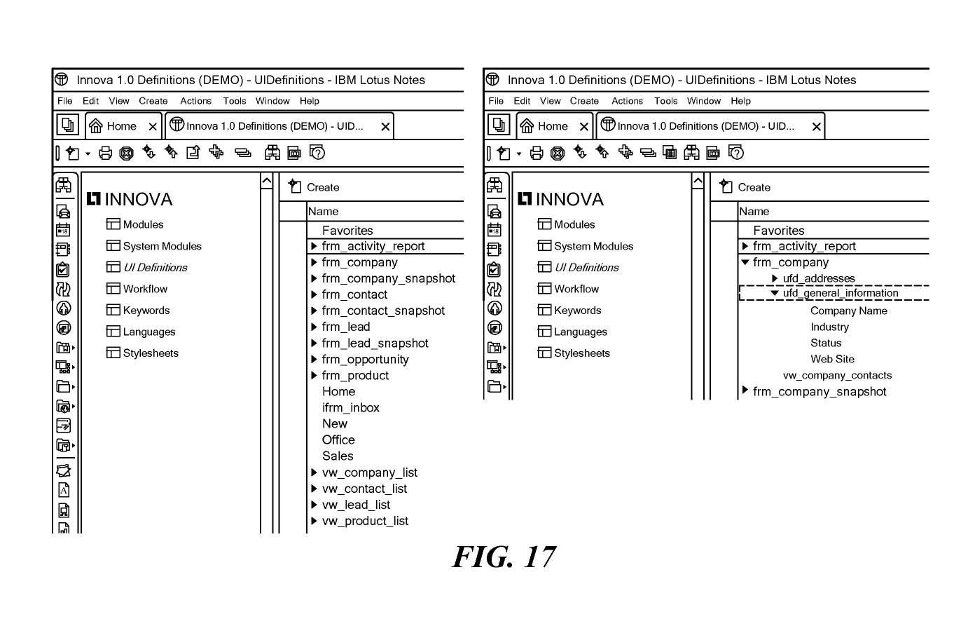

FIG. 17 is a representation of a computer display of two pages having definition lists for the user interface displayed thereon in accordance with the embodiment of FIG. 6.

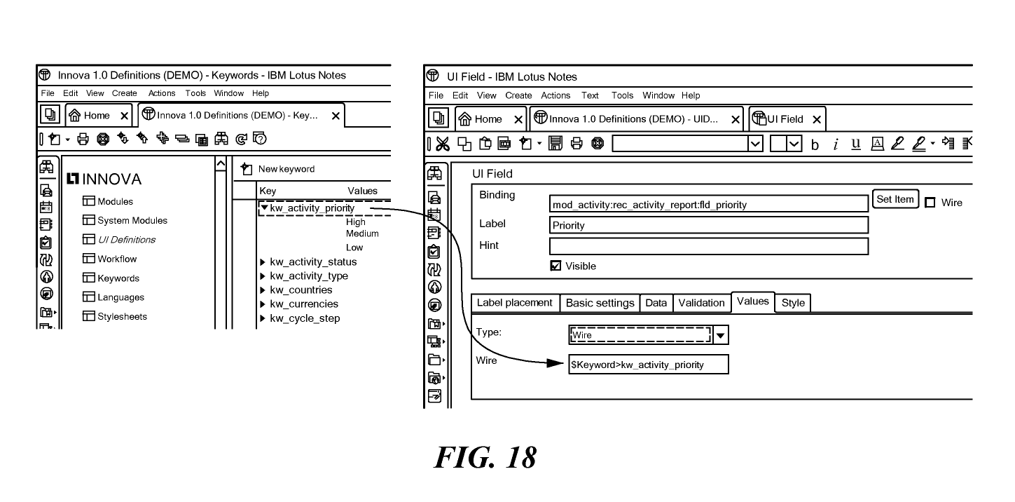

FIG. 18 is a representation of a computer display of two pages displaying a specification of keywords for a field definition in accordance with the embodiment of FIG. 6. Keywords can be defined and referred to in the user interface field definition.

As noted, a wire logically connects two record types together. This connection may be exploited to also connect two forms, which represent the respective records, together. This definition is used in the following ways. A wire may be used to provide prompts in a link tab to link to related records. The user interface may display a Link tab associated with a record (document) that allows the user to click to a related record responsive to the wire associated with the Link tab.

The wire may be used to synchronize fields between two documents connected by the wire.

Wires associated with the same field name in each of a number of records may be chained together, read recursively or read in reverse. For example, in a set of records that represent employees, if a portion of a record indicates an employee's supervisor, and an organization includes multiple levels of management, a supervisor's record includes an indication of the supervisor's supervisor. Thus, starting with an arbitrary target employee's record, it is possible to identify all the employee's direct reports by locating all the employee records that are linked to the target employee's employment record. Then, the process can be repeated for each of the direct reports to identify each of their direct reports, and so forth, until all of the target employee's direct and indirect reports are identified.

A wire may be used to provide related a view listing and the types that can be selected. For example, a “Company” wire can link a Company to an Invoice, so the company record will be able to display all invoices in the related view listing.

Workflows are well-known concepts in application software development. A process flow that may include user interaction. Each process is typically named and defined in terms of State, Action and Events. A workflow's state indicates in which of various possible stages a workflow item may be. Typically, a workflow includes a specific start and end state. Exemplary states may include New, Submitted and Approved. Each state may have one or more possible associated actions that are involved in transitioning to a next state. Each action may include one or more programmatic events, such as send e-mail message or execute a software agent.

A field defines validation rules and error messages produced, as well as additional information

These abstractions (wires, workflow and fields) are defined in the system configuration, such as the relationship information 204 (FIG. 2), and enable a software developer to design core modules without having to be concerned with meeting all potential customer needs upfront because, as a result of using the above-described concepts, the system may be easily tailored during deployment. From the developer's perspective, the described framework provides at least two advantages. The framework is flexible enough to allow configuration to drive the differentiation of business requirements and processes, rather than requiring the business requirements and processes to be hard-coded. In addition, the framework provides a set of tools that allow developers to concentrate on satisfying business requirements, rather than spending time re-inventing various wheels, such as workflow.

To meet these objectives, the framework provides the following features: user-(administrator-) accessible definitions that guide the behavior of the application; a hierarchy of Java code, based on the Model-View-Controller (MVC) pattern; a standard user interface, with behavior that is driven from the definitions; and simple event binding.

The application framework, according to embodiments of the present invention, makes use of keyword lookups and various levels of definition that are linked together, defining the module's application logic as a whole.

An application program no longer needs to be considered a monolithic database, with everything crammed inside, in order to achieve a desired business requirements.

With this framework, the focus shifts to designing modules that deliver core data capture (form) and listing (view) functionality, within a single Notes or other unstructured database. After building modules, application design and development should then focus on wiring modules together in a manner that meets current business requirements, together with defining a workflow that matches the business process.

Our choice of the term “wire” and “wiring” was intentional, because users connect two elements of an application together (with a wire). A wire represents a relationship between two fields or records that is stored as data and can be read by an application.

Thus, if contacts are related to projects, both types of record can capture the definition. The framework is then able to read the relationship and definitions and react accordingly. For example, this could result in displaying the contact field as a type-ahead field on the project record, to allow users select a contact to relate to the project. It should be noted that no code modifications are necessary to implement this functionality.

There are two types of wires when looking at them from the perspective of a current document. Inbound wires are wires where the current document is the target. Since the current document set the context, and the wire can only resolve to one source document, multiplicity is not possible, unless a wire is repeatedly (recursively) followed. Outbound wires are wires where the current wire is the Source. Since multiple targets can point to the source, multiplicity is implicit.

Wiring within the Innova framework has several capabilities. Any two documents may be linked from any defined module. Fields may be synchronized between two documents that are connected by a wire. A field in a source document may be read via a syntax, such as #wireName:fieldName#. Wires may be chained together to provide a complex data path, such as via a syntax similar to #wireName1:wireName2:wireName3:fieldName#. A wire may be read recursively until a search formula is satisfied, such as via a syntax similar to #wireName( ):fieldName# or #wireName(searchFormula):fieldName#. For example, recursive reading of a wire enables walking up a management chain to division level in a staff module. A wire may be read in reverse, which will usually return multiple results via a field name syntax, such as wireName[ ]:fieldName# or #wireName[SearchFormula]:fieldName#. For example, totaling an invoice may be accomplished with a syntax, such as {@Sum(#Invoices:Price#)}.

The framework allows a user to define any number of process flows. These can be implemented with or without human interaction, either implicitly through the interface or explicitly in LotusScript code, e.g., an agent marking stale claims. A process can be defined in terms of state, action and event. “State” represents the various states in the process, with a specified start and end state. Exemplary states include New, Submitted and Approved. “Action” represents various actions that can be performed for each state, such as Submit or Reject. “Event” represents various programmatic events that make up an action, such as change state, send mail, run an agent, etc.

Once defined, these process flows can be assigned to a module's form definition. This then drives the interface to display the Actions available to the current document in the Document mode, and when selected, causes execution of the events associated with that action.

### Class Hierarchy

As noted, aspects of embodiments may be implemented according to the MVC pattern. Within this context, the framework logic resides in a controller. Appropriate classes are generally called controllers. Base controller functionality defines an access regime to the model and sets up standard interfaces. Namespace controller functionality allows the application to drive behavior from a Namespace string, in a form such as “Module.Form.Wire.” Wiring controller functionality allows various data elements (forms) to be related to each other using namespaces. The two forms can be in totally different databases.

The Workflow engine simply takes the definition for the reference document and makes the defined actions available, if applicable. Then, if an action is triggered, the associated events are run by the engine. Workflow can be viewed as two separate layers: back end and user interface. The back end requires no user interaction to start or progress along the workflow process. The user interface is used to present actions to the user and to allow for user interaction and inputting while running an event.

The View portion includes custom user interface (UI) classes and extends the workflow classes. The custom classes provide the following several benefits, such as the following benefits: a standardized UI that allows easy viewing and access to multiple facets of related information; and simple event binding (for example, three lines of code on a QueryOpen event make all the events on that Notes user interface element available to the framework, without any further code).

There is an additional portion of the framework that overlays the View and Controller portions with application-specific extensions. These are found in the Module libraries, which are named as follows:

“module<ApplicationName>BE” (back end)—extends classes from the Controller portion. Application-specific logic that cannot be captured in the definitions may be placed here.

“module<ApplicationName>UI” (user interface)—extends classes from the View portion. The UI class may need to instantiate a class from the above back-end.

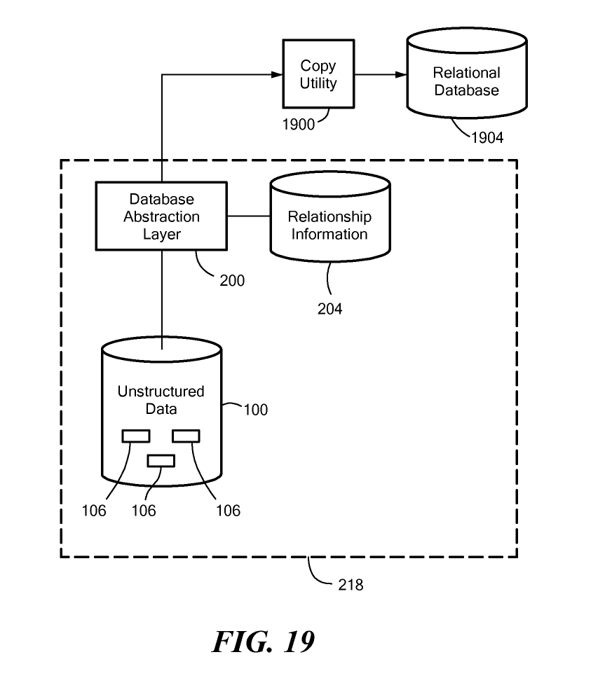

Another embodiment of the present invention may be used to create or populate a relational database from unstructured data, as shown schematically in FIG. 19. A copy utility 1900 access a virtual relational database system 218 provided by the database abstraction layer 200. The copy utility 1900 copies data, such as in the form of tables, from the virtual relational database 218 to a new or existing relational database 1904.

Aspects of the present disclosure, such as the database abstraction layer and methods for constructing a data application, may be implemented by a processor controlled by instructions stored in a memory. The memory may be random access memory (RAM), read-only memory (ROM), flash memory or any other memory, or combination thereof, suitable for storing control software or other instructions and data. Some of the functions performed by the database abstraction layer and methods for constructing a data application have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of database abstraction layer and methods for constructing a data application have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

What is claimed is:

1. A non-volatile computer-readable storage medium encoded with instructions which, when loaded into a computer, establish a computer-implemented method for constructing a data application for operation in a computer system running an unstructured data environment, the construction of the application being accomplished in the environment, the method comprising:
establishing processes running in the computer system that define properties of, and relative behavior of, data entities in an abstraction layer, such data entities including module, index, record, item, and wire; wherein the data entities are configured to support reading and writing to storage in the data environment through a wire and through an item;
receiving and storing a user data model input defining a data model using the data entities; and
on receipt of a user signal, processing the data model input to develop a representation reflecting the data model, and generating signals defining a display of the representation and the application, such display permitting user interaction as specified in the data model input;
so that the resulting data application implements normalized data in the unstructured data environment.

2. A non-volatile computer-readable storage medium according to claim 1, wherein:
establishing processes running in the computer system includes establishing processes running in the computer system that define properties of, and relative behavior of, presentation entities in a presentation layer, the presentation entities including grouplet, field set, field, view, and column;
the method further comprising:
receiving and storing a user presentation input defining a presentation for the data model, using the presentation entities, and
on the on receipt of the user signal, processing the data model input to develop a representation of the presentation and its linkage to the data model, and generating signals defining a display of the representation and the application, such display permitting user interaction as specified in the data model input and the presentation input.

3. A non-volatile computer-readable storage medium according to claim 2, wherein the presentation entities further include group space.

4. A non-volatile computer-readable storage medium encoded with instructions which, when loaded into a computer, establish a computer-implemented method for constructing a data application for operation in a computer system running an unstructured data environment, the construction of the application being accomplished in the environment, the method comprising:
establishing processes running in the computer system that (i) define properties of, and relative behavior of, data entities in an abstraction layer, such data entities including module, index, record, item, and wire, and (ii) define properties of, and relative behavior of, presentation entities in a presentation layer, the presentation entities including grouplet, field set, field, view, and column;
wherein the data entities are configured to support reading and writing to storage in the data environment through a wire;
receiving and storing a user data model input defining a data model using the data entities;
receiving and storing a user presentation input defining a presentation for the data model, using the presentation entities; and
on receipt of a user signal, processing the data model input and the presentation input to develop a representation of the presentation and its linkage to the data model, and generating signals defining a display of the representation and the application, such display permitting user interaction as specified in the data model input and the presentation input;
so that the resulting data application implements normalized data in the unstructured data environment.
